(19) United States
(12) Patent Application Publication
(10) Pub. No.: US 2016/0133251 A1
(43) Pub. Date: May 12, 2016

(54) PROCESSING OF AUDIO DATA

(71) Applicant: LONGSAND LIMITED, Cambridge (GB)

(72) Inventors: Maha Kadirkamanathan, Cambridge (GB); David Pye, Cambridge (GB); Travis Barton Roscher, St. Petersburg, FL (US)

(21) Appl. No.: 14/890,538

(22) PCT Filed: May 31, 2013
(86) PCT No.: PCT/EP2013/061321

§ 371 Date: Nov. 11, 2015

(51) Int. Cl. G10L 15/197; G10L 15/26; G06F 17/30

(52) U.S. Cl. CPC G10L 15/197; G06F 17/30746; G10L 15/26

(57) ABSTRACT

Examples of processing audio data are described. In certain examples, a transcript language model is based on text data representative of a transcript associated with the audio data. The audio data is processed to determine at least a set of confidence values for language elements in a text output of the processing, wherein the processing uses the transcript language model. The set of confidence values enable a determination to be made. The determination relates to whether the text data is associated with said audio data based on said set of confidence values.

### BACKGROUND

The amount of broadcast media content across the world is increasing daily. For example, more and more digitalized broadcasts are becoming available to the public and private parties. These broadcasts include television and radio programs, lectures and speeches. In certain cases, there is often a requirement that such broadcasts have accurately labeled closed-captions. For example, to meet accessibility requirements, closed-caption text needs to accompany broadcasts, for example being displayed simultaneously with audio and/or video content. This is becoming a legal requirement in some jurisdictions. In research and product development teams, it is also desired to align text data with associated audio data such that both media may be used in information retrieval and machine intelligence applications.

### BRIEF DESCRIPTION OF THE DRAWINGS

Various features and advantages of the present disclosure will be apparent from the detailed description which follows, taken in conjunction with the accompanying drawings, which together illustrate, by way of example only, features of the present disclosure, and wherein:

FIG. 1 is a schematic diagram of a system according to an example;

FIG. 2A is a schematic diagram showing at least a portion of audio data according to an example;

FIG. 2B is a schematic diagram showing at least a portion of text data according to an example;

FIG. 3 is a flow chart showing a method of processing audio data according to an example;

FIG. 4A is a schematic diagram of a system for aligning audio and text data according to an example;

FIG. 4B is a schematic diagram showing at least a portion of text data with appended timing information according to an example;

FIG. 4C is a schematic diagram of a system for aligning audio and text data according to an example;

FIG. 5 is a flow chart showing a method of audio processing according to an example;

FIG. 6 is a flow chart showing a method of determining an association of at least a portion of audio data according to an example;

FIG. 7 is a schematic diagram showing a system for processing at least a portion of audio data according to an example;

FIG. 8 is a flow chart showing a method of determining an association of at least a portion of audio data according to an example; and

FIG. 9 is a schematic diagram of a computing device according to an example.

### DETAILED DESCRIPTION

Certain examples described herein relate to processing audio data. In particular, they relate to processing audio data based on language models that are generated from associated text data. This text data may be a transcript associated with the audio data. In one example, audio data is converted into a text equivalent, which is output from the audio processing. In this case, a further output of the audio processing is timing information relating to the temporal location of particular audio portions, such as spoken words, within the audio data. The timing information may be appended to the original text data by comparing the original text data with the text equivalent output by the audio processing. In another example, probability variables, such as confidence values, are output from a process that converts the audio data to a text equivalent. For example, confidence values may be associated with words in the text equivalent. These probability variables may then be used to match text data with audio data and/or determine a language for unlabeled audio data.

In order to better understand a number of examples described herein comparisons will now be made with a number of alternative techniques for processing of audio and text data. These alternative techniques are discussed in the context of certain presently described examples.

The task of aligning broadcast media with an accurate transcript was traditionally performed manually. For example, they may be manually inspected and matched. This is often a slow and expensive process. It is also prone to human error. For example, it may require one or more human beings to physically listen to and/or watch a broadcast and manually note the times at which words in the transcript occur.

Attempts have been made to overcome the limitations of manual alignment. One attempt involves the use of a technique called force-alignment. This technique operates on an audio file and an associated transcript file. It determines a best match between a sequence of words in the transcript file and the audio data in the audio file. For example, this may involve generating a hidden Markov model from an exact sequence of words in a transcription file. The most likely match between the hidden Markov model and the audio data may then be determined probabilistically, for example by selecting a match that maximizes likelihood values.

While force-alignment may offer improvements on the traditional manual process, it may not provide accurate alignment in various situations. For example, the process may be vulnerable to inaccuracies in the transcript. Spoken words that are present in the audio data but are missing from the transcript, and/or written words that are present in the transcript but are missing from the audio data, can lead to misalignment and/or problems generating a match. As force-alignment builds a probability network based on an exact sequence of words in a transcript file, missing and/or additional words may lead to a mismatch between the probability network and the audio data. For example, at least a number of words surrounding omitted context may be inaccurately time-aligned. As another example, the process may be vulnerable to noise in the audio data. For example, the process may suffer a loss of accuracy when music and/or sound effects are present in the audio data.

Another attempt to overcome the limitations of manual alignment involves the use of speech recognition systems. For example, a broadcast may be processed by a speech recognition system to automatically generate a transcript. This technique may involve a process known as unconstrained speech recognition. In unconstrained speech recognition, a system is trained to recognise particular words of a language, for example a set of words in a commonly used dictionary. The system is then presented with a continuous audio stream and attempts are made to recognise words of the language within the audio stream. As the content of the audio stream may include any words in the language as well as new words that are not in a dictionary the term “unconstrained” is used. As new words are detected in an audio stream they may be added to the dictionary. As part of the recognition process, a speech recognition system may associate a recognised word with a time period at which the recognised word occurred within the audio stream. Such a system may be applied to video files that are uploaded to an online server, wherein an attempt is made to transcribe any words spoken in a video.

While unconstrained speech recognition systems provide a potentially flexible solution, they may also be relatively slow and error prone. For example, speech recognition of an audio stream of an unpredictable, unconstrained, and/or uncooperative nature is neither fast enough nor accurate to a degree acceptable to viewers of broadcast media.

Certain examples described herein may provide certain advantages when compared to the above alternative techniques. A number of examples will now be described with reference to the accompanying drawings.

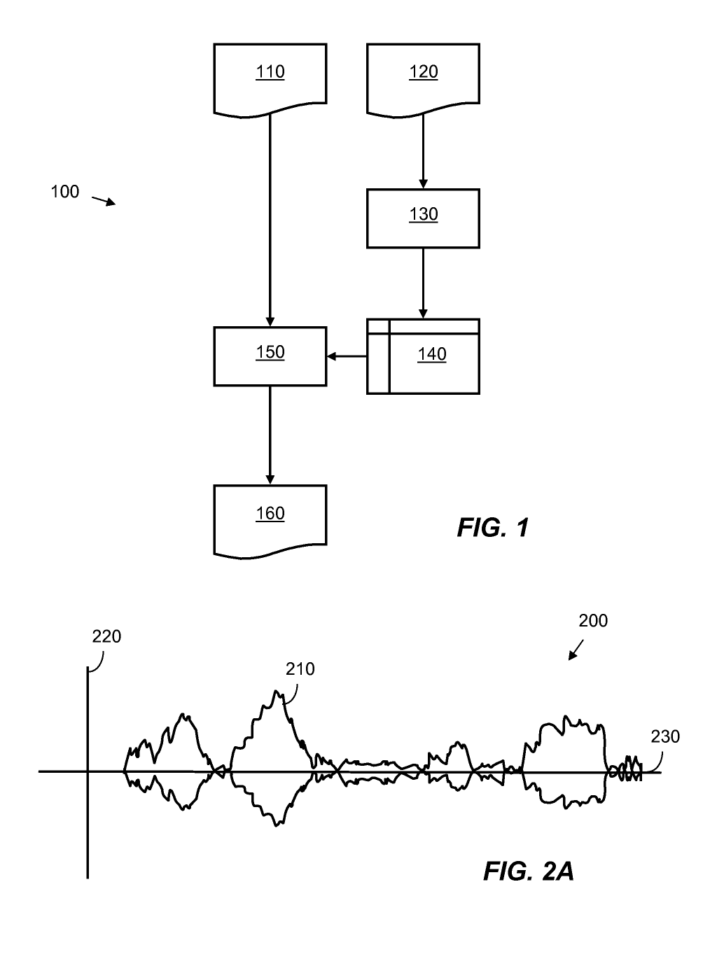

FIG. 1 is a schematic diagram showing a system 100 for processing audio and text data. The system takes as an input audio data 110 and text data 120. The audio data may comprise at least a portion of an audio track for a video. The audio data may be associated with, amongst others, broadcast media, such as a television or radio program, or a recording of a speech or lecture. The text data 120 may comprise at least a portion of a transcript associated with the audio data, e.g. a written representation of a plurality of words within the audio data.

The system 100 comprises a first component 130 and a second component 150. The first component 130 at least instructs the generation and/or configuration of a language model 140 using the text data 120 as an input. The language model 140 is configured based on the contents of the text data 120. For example, if the language model 140 comprises a statistical representation of patterns within a written language, the language may be limited to the language elements present in the text data 120. The second component 150 at least instructs processing of the audio data 110 based on the language model 140. The second component 150 outputs processing data 160. The processing of the audio data 110 may comprise a conversion of the audio data 110 into a text equivalent, e.g. the automated transcription of spoken words within the audio data 110. The text equivalent may be output as processing data 160. Alternatively, or as well as, data relating to a text equivalent of the audio data 110, processing data 160 may comprise data generated as a result of the conversion. This may comprise one or more metrics from the conversion process, such as a probability value for each detected language element in the audio data 110. Processing data 160 may also comprise timing information. This timing information may indicate a temporal location within the audio data where a detected language element occurs.

An advantage of the system 100 of FIG. 1 is that the processing of audio data 110 is performed based on a language model 140 that is constrained by the contents of the accompanying text data 120. As it is assumed that the text data 120 corresponds to the audio data 110, the language model 140 biases the processing of the audio data 110 accordingly. This may be compared to processing based on a general language model representing a significant portion of the words that could be present in unconstrained speech. Processing based on a general language model is more likely to misclassify portions of the audio data as there is a much wider set of candidate classifications. Comparatively, common misclassifications may be avoided with a constrained language model as, for example, alternative classifications may not be present in the text data.

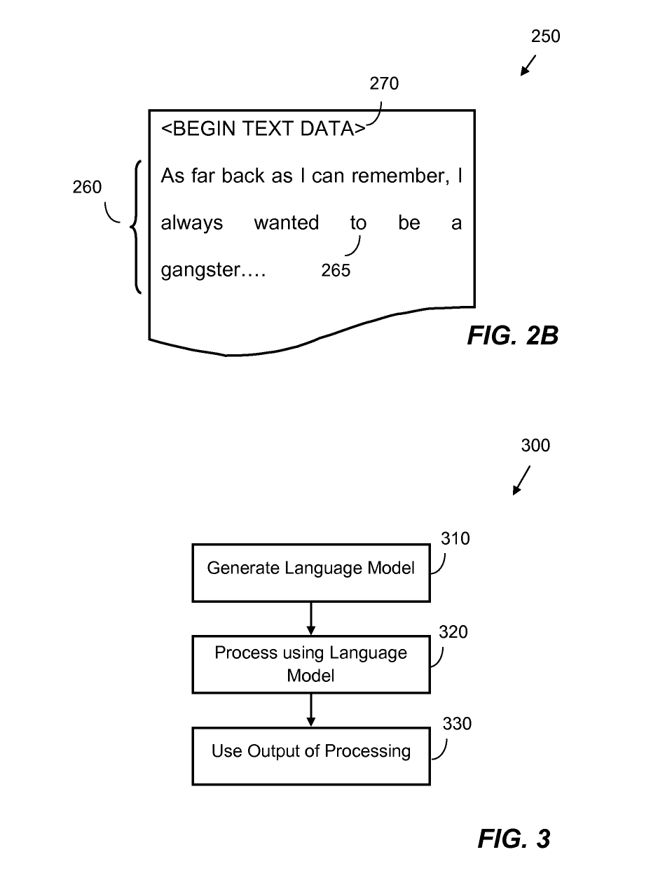

FIGS. 2A and 2B provide respective examples of audio data 110 and text data 120. As shown in FIG. 2A, in certain implementations, audio data may comprise a digital representation 200 of sound recorded by one or more microphones. The audio data may comprise a number of digital samples 210 that extend over a time period 230, wherein each sample is represented by an p-bit or p-byte data value 220. For example, in a simple case compact disc digital audio comprises 16-bit data values with 44,100 samples per second (i.e. a sampling rate of 44.1 kHz). Each sample may represent an analog voltage signal from a recording device following analog-to-digital conversion. The audio data may comprise one or more channels of a multi-channel recording (e.g. for a stereo recording there may be two channels). The audio data may be compressed, for example using a known standard such as those developed by the Moving Picture Experts Group. In these cases, processing of audio data may comprise appropriate pre-processing operations such as, amongst others, normalization, resampling, quantization, channel-selection and/or decompression.

FIG. 2B shows one implementation of text data 120. In this case, the text data comprises a data file 250. In FIG. 2B, the data file 250 comprises a plurality of words 260 that are representative of spoken language elements within the audio data. The data file 250 may comprise machine-readable information 270 such as headers, footers, labels and control information. Each word may be stored as a binary value using any text-encoding standard. For example, the word “to” 265 in FIG. 2B may be represented in an American Standard Code for Information Interchange (ASCII) text file as two 7-bit values “1110100 1101111” or as two Universal Character Set Transformation Format 8-bit (UTF-8) values “01110100 01101111”.

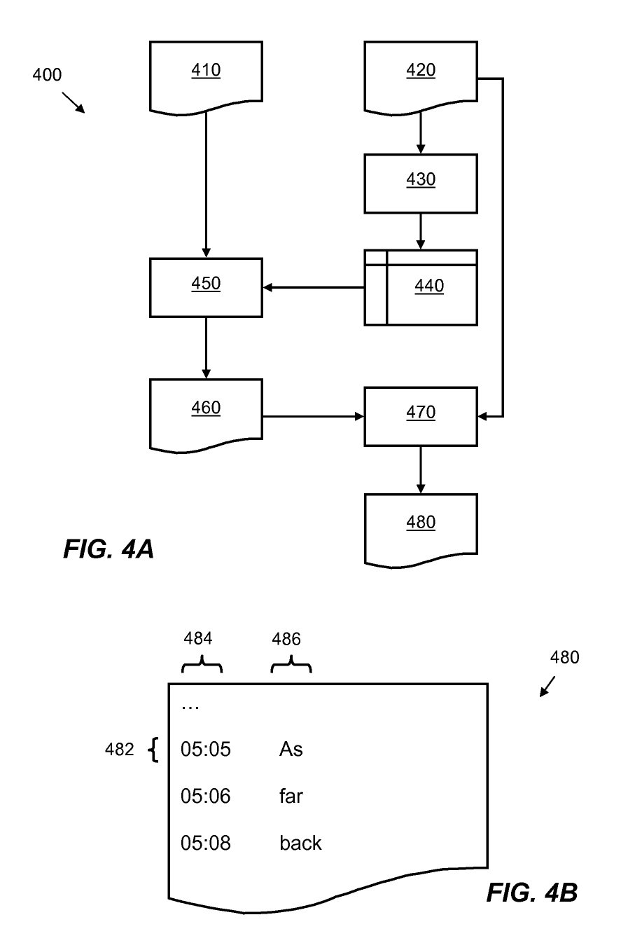

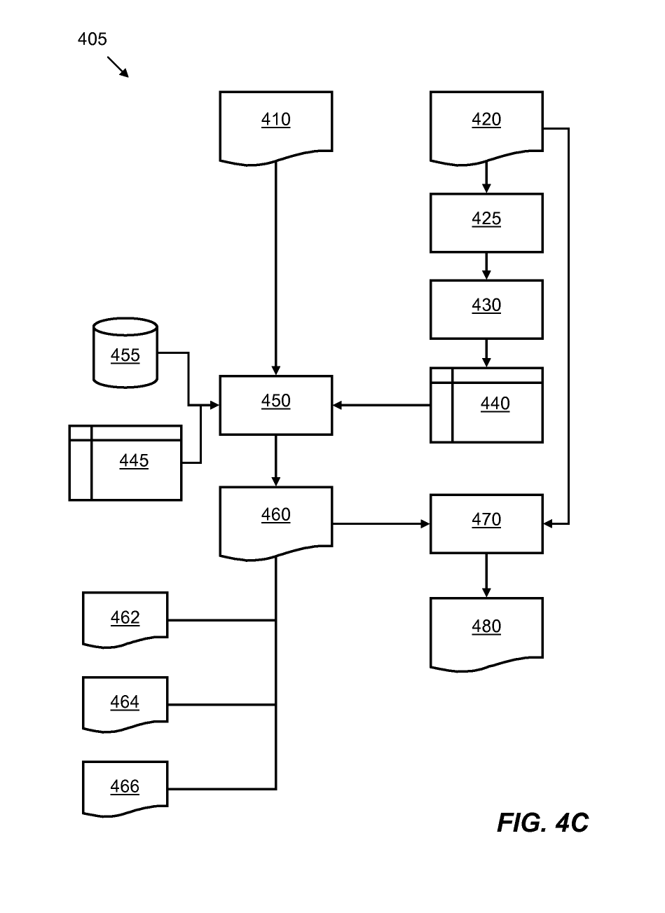

FIG. 3 shows a method 300 of processing audio data according to an example. The method 300 of FIG. 3 may be implemented using the system components of FIG. 1 or may be implemented on an alternative system. At block 310, a language model is generated. This may comprise generating a transcript language model based on text data representative of a transcript. The text data and/or the transcript may be received from an external source. It may comprise closed-caption text data. A language model may be generated according to a model generation process that takes as an input text training data, wherein in the present case the text data is supplied to the model generation process as input text training data. At block 320, the generated language model is used to process audio data associated with the transcript. The audio data may also be received from an external source, e.g. together with or separate from the text data. For example, a speech recognition process may be applied to the audio data, wherein in this case the speech recognition process uses the generated language model to perform the speech recognition. At block 330, an output of the processing is used to determine properties of the audio data and/or text data. In one example, the output of the processing comprises timing data that is used to align the text data with the audio data. In another example, which may form part of the previous example or be implemented separately, the output of the processing comprises probability values that are used to match particular sets of text and audio data. This matching processing may be used to determine a language of spoken elements within the audio data. These two examples are described in more detail with reference to FIGS. 4A to 8 below.

FIG. 4A shows a system 400 for aligning text data with audio data according to an example. The system 400 may be seen as an extension of the system 100 of FIG. 1. The system 400 operates on audio data 410 and text data 420. The audio data 410 may comprise an audio track of multimedia content such as a television broadcast or film. The audio data 410 may be supplied independently of any associated multimedia content or may be extracted from the multimedia content by an appropriate pre-processing operation. The text data 420 may comprise closed-caption data. In this case, “closed-caption” is a term used to describe a number of systems developed to display text on a television or video screen. This text provides additional or interpretive information to viewers who wish to access it. Closed captions typically display a transcript of the audio portion of a program as it occurs (either approximately verbatim or in edited form), sometimes including non-speech elements. Most commonly, closed captions are used by deaf or hard of hearing individuals to assist comprehension.

In a similar manner to FIG. 1, the system 400 of FIG. 4A comprises a first component 430, a second component 450 and a third component 470. In the present case, the first component 430 comprises an interface to receive text data 420 and a model generator to generate a transcript language model. In other examples, such as those in a distributed processing environment, the first component 430 may instruct an external interface and/or model generator. After the text data 420 is received by the interface of the first component 430 it is passed to the model generator. The model generator is arranged to generate a transcript language model 440 based on the text data 420. The transcript language model 440 may comprise one or more data structures arranged to store statistical data that is representative of language element patterns, such as word patterns, in a written language. The written language is typically the written language of the text data. The word patterns comprise patterns that may be derived from the text data 420. In certain implementations, the transcript language model is a statistical N-gram model where only the text data 420 is used in its creation.

In FIG. 4A, the second component 450 comprises an interface to receive audio data 410 and a speech-to-text engine. In other examples, such as those in a distributed processing environment, the second component 450 may instruct an external interface and/or speech-to-text engine. The speech-to-text engine is arranged to use the transcript language model 440 to covert spoken words that are present in the audio data 410 to text (e.g. data defined in a similar manner to FIG. 2B). The transcript language model 440 steers the speech-to-text engine towards identifying the words in the text data 420 while also preserving the word ordering in the text data 420, e.g. as part of an N-gram model. The speech-to-text engine may be arranged to take as an input a data stream or file representative of the audio data shown in FIG. 2A and to output a text-character stream or file 460. This text-character stream or file 460 may share characteristics with the text data shown in FIG. 2B, e.g. may comprise recognised words encoded in a standard text-encoding format. The text character stream or file 460, also referred to herein as a text equivalent of the audio data 410, comprises words and phrases that have been recognised in the audio data 410. As such it may not comprise the full set of spoken words present in the audio data 410; certain words in the audio data may be omitted or misclassified, i.e. the text character stream or file 460 may not be 100% accurate. In the present case, the speech-to-text engine also outputs timing information. For example, recognised words in the text character stream or file 460 may have an associated timestamp representing a time in the audio data 410 when the word is spoken.

In FIG. 4A, the third component 470 is arranged to receive both the text data 420 and the text character stream or file 460. The third component 470 compares language elements (in this example, words) in the text data 420 and the text character stream or file 460 so as add or append at least a portion of the timing information associated with the text character stream or file 460 to the text data 420. For example, the timing information may comprise a list of time-marked words. These words can then be matched to words present in the text data 420. Where a match occurs, e.g. within the context of a particular phrase or word order, then a timestamp associated with a word from the text character stream or file 460 may be appended to the matched word in the text data 420. Where closed-caption data is used this then provides time information for each closed-caption utterance. A time-indexed version of the text data 480 is then output by the third component 470.

FIG. 4B shows a time-indexed version of the text data 480 according to an example. In this case, the original text data 420 comprises the text data shown in FIG. 2B. In the example of FIG. 4B, the time-indexed version of the text data 480 comprises a number of (time, word) tuples 482. The “time” component 484 of each tuple 482 comprises a time from an index point of the audio data 410. In certain cases this may comprise a start time of the audio data 410 or a bookmarked time point within a larger body of audio data. The “word” component 486 comprises one or more of the words that were present in text data 420. The information in the time-indexed version of the text data 480 may be used in several ways, including to accurately display closed-captions with associated spoken words and/or to index audio and/or video data for indexing or machine processing purposes. It should be noted that not all words in the original text data 420 may be time-indexed, certain words that are not present in a text equivalent may not have a time value.

FIG. 4C shows a system 405 that is a variation of the example of FIG. 4A. In a similar manner to FIG. 4A, the system 405 of FIG. 4C comprises a first component 430, a second component 450 and a third component 470. In addition to these components the system 405 comprises a fifth component 425. The fifth text component 425 incorporates an interface arranged to receive text data 420 and a text normalizer. The text normalizer applies text normalization to the received text data 420. Text normalization may involve placing the text data 420 in a canonical form, i.e. processing text data 420 such that it complies with a set of predefined standards. These standards may cover areas such as formatting. Text normalization may also comprise processing all non-alphabetical characters in the text data 420, for example mapping non-alphabetical characters in the text data such as numbers and dates to an alphabetical word form. In this manner, “12/12/12” may be converted to “twelfth of December two-thousand-and-twelve” and “1” may be converted to “one”. Text normalization may also be used to remove non-speech entries such as stage direction or other sound indications (e.g. “[Background music is playing]”). The output of the text normalizer is then supplied to the first component 430 to enable the generation of a transcript language model based on the normalized text data.

FIG. 4C also demonstrates how the speech-to-text engine of the second component 450 may use an acoustic model 445 as well as a transcript language model 440 to convert audio data into a text equivalent. In this case the transcript language model 440 embodies statistical data on occurrences of words and word sequences and the acoustic model 445 embodies the phonemic sound patterns in a spoken language, captured across multiple speakers. In one implementation the speech-to-text engine may comprise an off-the-shelf speech-to-text engine that is arranged to use a language model and an acoustic model. In this case, a general language model representing statistical patterns in a language as a whole may be replaced with a transcript language model for each portion of text data. The acoustic model 445 may be a general or standard speaker-independent acoustic model. FIG. 4C shows how a pronunciation dictionary 455 may also be used to map words to the phonemic sound patterns. The mapped words may be those defined by the transcript language model.

In the example of FIG. 4C an output 460 of the second component 450 has three components: a set of words 462 that were detected or recognised in the audio data 410; timing information 464 associated with said words; and confidence values 466. These three components may be stored as a triple (e.g. “word/time/confidence value”) or as associated records in three separate data structures. The confidence values 466 indicate how well a portion of the audio data matched the recognised word. For example, they may comprise probability or likelihood values representing how likely the match is (e.g. as a percentage or normalized value between 0 and 1). As such they may be referred to as “acoustic” confidence values. All three components of the output 460 may be used by the third component 470 to align the text data 420 with the audio data 410, e.g. to mark one or more words in the text data 420 with time information relative to (i.e. in reference to one of more fixed time points in) the audio data 410. In certain examples, a match between a recognised word output by the second component 450 and a word in the text data 420 may depend on a generated confidence value, e.g. a match is only deemed to be present when a generated confidence value for a word is above a predefined threshold.

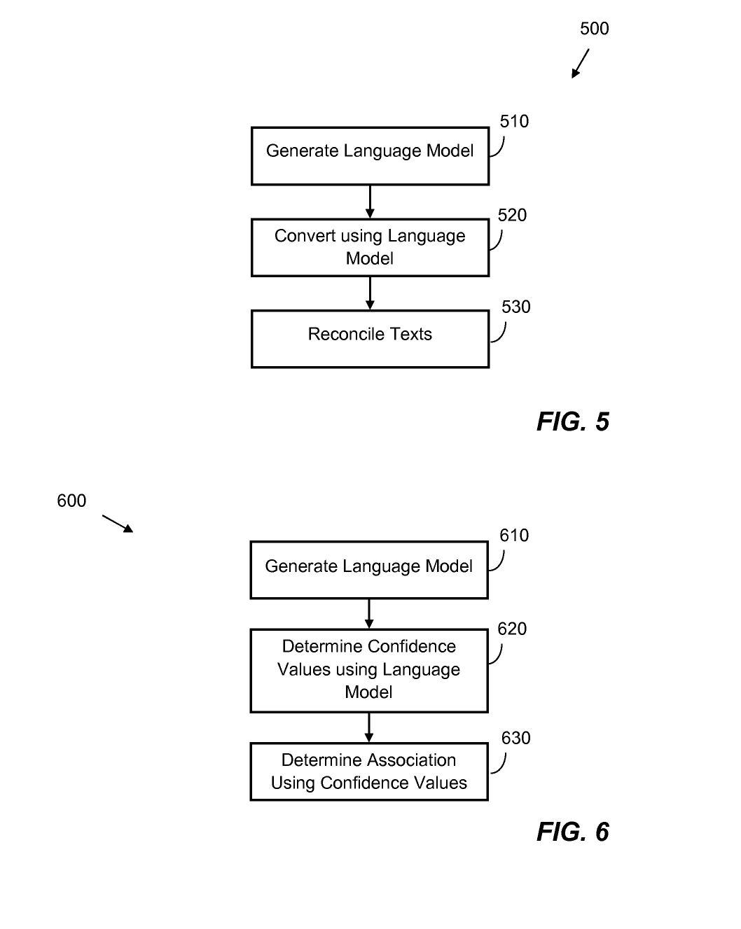

FIG. 5 shows a method 500 to align audio and text data according to an example. This method 500 may be implemented by any one of the systems 400, 405 in FIGS. 4A and 4C or by another system not shown in the Figures. At block 510, a language model is generated based on input text data. The input text data may be a transcript of audio data. The audio data may be at least a portion of an audio track associated with a broadcast. At block 520, audio data associated with the input text data is converted into text by a speech-to-text or speech recognition process. This process is configured to use the language model generate in block 510. The output of block 520 is a text equivalent to the audio data and associated timing information. This may be a text stream or file. At block 530, the text equivalent is then reconciled with the input text data so as to append at least a portion of the timing information to the input text data.

Certain examples described above enable fast and accurate speech recognition. Recognition is fast as the transcript language model is of a reduced size compared to a general language model. Recognition is accurate as it is limited to the language elements in the transcript language model.

Certain examples that utilize at least a portion of the techniques described above will now be described with reference to FIGS. 6 to 8. These examples may be implemented in addition to, or independently of, the previously described examples. In these examples, processing of audio data based on a text-data-limited language model is used to determine an association between at least a portion of text data and at least a portion of audio data. The strength of the association may be used to determine one or more languages represented within the audio data.

FIG. 6 shows a method 600 for determining one or more languages represented within audio data according to an example. The method 600 shares certain similarities with methods 300 and 500 of FIGS. 3 and 5. At block 610, a language model is generated based on received text data in a similar manner to blocks 310 and 510 of FIGS. 3 and 5. At block 620, the generated language model is used to process audio data associated with the received text data. In this case, the processing determines confidence values for a plurality of words that are recognised in the audio data, the recognition operation being based on the generated language model. The processing need not output the word matches themselves; however, if the method 600 is applied together with the method 500 of FIG. 5, the confidence values may be output with the word matches. At block 630, the confidence values generated at block 630 are analyzed to determine an association of the processed audio data. This determination may be probabilistic. In one implementation, at least one statistical metric calculated based on the confidence values may be compared with a respective threshold. If the at least one statistical metric is above a corresponding threshold then it may be determined that the text data is associated with the audio data. Comparatively, if the at least one statistical metric is below a corresponding threshold then it may be determined that the text data is not associated with the audio data. The case where the metric equals the threshold may be configured to fall into one of the two cases as desired. If the text data is labeled as relating to a particular language (e.g. English, Spanish, Mandarin, etc.) then this label may then be associated with the audio data. The converse case may also apply: if the audio data is labeled as relating to a particular language then this label may then be associated with the text data. This enables a determination of the language of the audio and/or text data. In certain cases, the text data and the audio data may comprise a segmented portion of a larger audio track. In this case, each segmented portion may have an associated language determination.

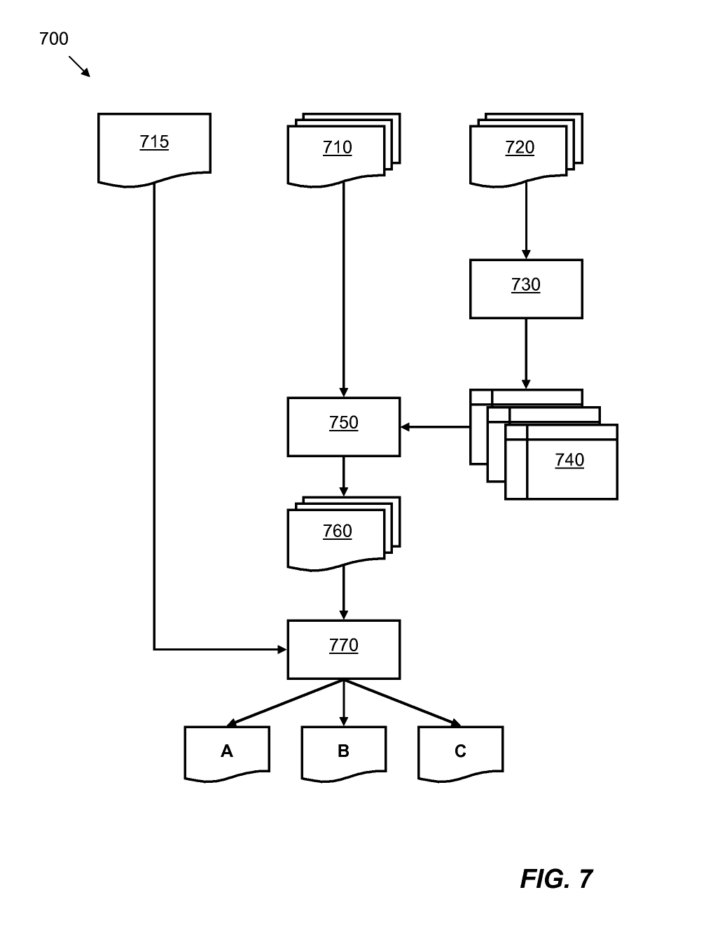

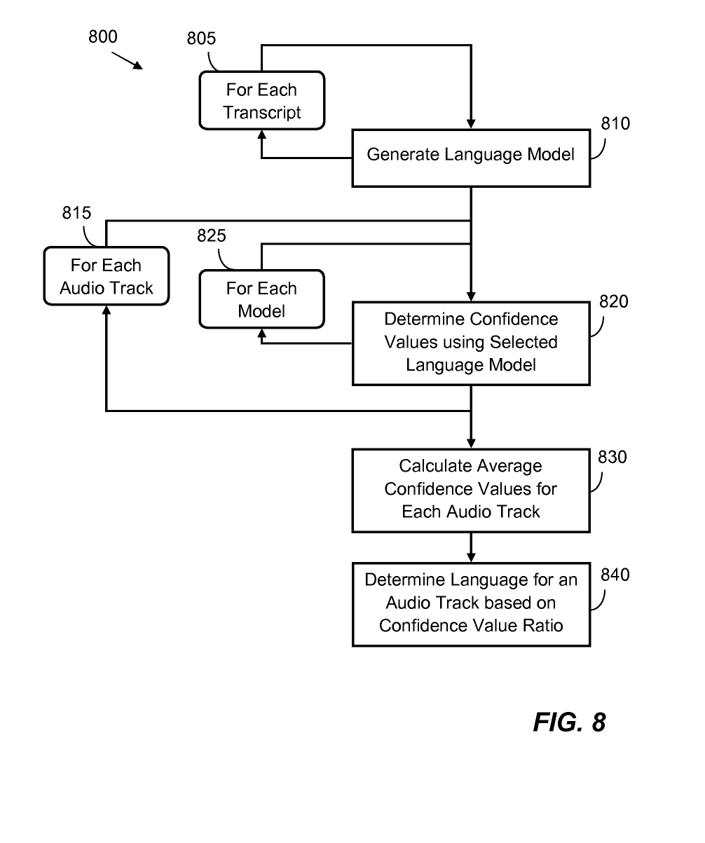

FIG. 7 shows a system 700 for determining one or more languages represented within audio data according to an example. This system 705 may implement the method of FIG. 6. The system 705 is similar to systems 100 and 400 of FIGS. 1 and 4. The system 700 comprises a first component 730 arranged to at least instruct the configuration of a language model based on input text data and a second component 750 arranged to process audio data associated with the input text data. In the example of FIG. 7, the audio data comprises a plurality of audio portions and the text data comprises a plurality of text portions 720. An audio portion may be an audio track in a particular spoken language, or a portion of said track. A text portion may be a transcript of said audio track, or a portion of said transcript associated with a corresponding portion of the audio track. For example, in the case of a film or television program, said film or program may have a plurality of audio tracks and a respective plurality of corresponding closed-caption files. In the example of FIG. 7, a list of languages 715 is also provided; for example, this may list each of the languages that have an audio track and a closed-caption file, e.g. define a predetermined set of languages. Although in this example the list of languages 715 is given “a priori”, in certain implementations it may be determined implicitly from one or more of the audio and text data, for example

The system 700 of FIG. 7 is arranged to effectively create an audio processing system as for example shown in FIG. 1 for each language in the list of languages 715, i.e. for each language that has associated audio and text data. As such, the first component 730 is at least arranged to instruct the configuration of a language model for each of the plurality of text portion 720. This operation results in a plurality of language models 740, effectively one model for each language as represented in the text portions 720. The second component 750 is then arranged to instruct a plurality of processing operations for at least one of the audio portions, each processing operation using a respective one of the generated language models 740. Taking one of the audio portions 710 to begin with, the processing of the selected audio portion results in a set of outputs 760, each output being associated with a particular language model 740 that is in turn associated with a particular text portion. Each output comprises a set of confidence values for a plurality of recognised words in the selected audio portion. The system 700 further comprises a fourth component 770 that is arranged to determine a language for at least one audio portion. For a selected audio portion, the set of outputs 760 is received by the fourth component 770. The fourth component 770 then analyzes the confidence values with the set of outputs 760 to determine a likely language for the selected audio portion. In one implementation the fourth component 770 may calculate an average of a set of confidence values for each output and an average of the set of confidence values for the complete set of outputs 760. These two average values may then be used to calculate a likelihood ratio for a particular output; for example, for a selected audio portion and one output based on a particular language model, a likelihood metric may comprise: (confidence value average for output)/(confidence value average for all outputs). The output with the highest ratio may then be selected as the appropriate output for the selected audio portion. This process may be repeated for each audio portion in the plurality of audio portions 710. In this case, an output of the fourth component 770 may comprise a matrix of metrics.

The fourth component 770 may use a likelihood metric, and/or matrix of metrics, as described above in several ways. In a first case, the likelihood metric may be used to match audio and text portions from respective ones of the plurality of audio portions 710 and the plurality of text portions 720. If one or more of the audio portions and text portions are unlabeled, the likelihood ratio may be used to pair an audio portion with a text portion of the same language. For example, a set of unlabeled audio tracks for a plurality of languages may be paired with unlabeled closed-caption text for the same set of languages. In a second case, if one of the audio portions and text portions are labeled but the other is not, the likelihood metric may be used to label the unlabeled portions. For example, if closed-caption text is labeled with a language of the text this language label may be applied to a corresponding audio track. This is shown in FIG. 7 wherein the output of the fourth component 770 is a set of labeled portions (A, B, C etc.). In a third case, if both the audio portions and text portions are labeled, the likelihood metric may be used to confirm that the labeling is correct. For example, the likelihood metric may be used to determine whether audio tracks are correctly aligned with configuration information. If a list of languages 715 is supplied then an automated check may be made that those languages are present in the plurality of text and/or audio portions. For example, if a set of likelihood ratios for a particular audio portion has a maximum value that is below a predetermined threshold, this may indicate that there is no corresponding text portion for this audio portion. This may indicate that one of the languages in the list is incorrect with respect to at least one audio and/or text portion.

FIG. 8 shows a method 800 of processing audio data. This method 800 may be implemented on the system 700 of FIG. 7 or on a system that is not shown in the Figures. At block 805, a first text portion is selected. In this case, the text portion is a transcript of an audio file. This may be represented as a text-based file in a file system. At block 810, a language model is generated based on the language elements of the transcript. In the present case these language elements are a plurality of words but they may also comprise, amongst others, phonemes and/or phrases. As shown by block 805 in FIG. 8, block 810 is repeated for each transcript in a given set of transcripts. The output of this first loop is thus a plurality of language models, each language model being associated with a particular transcript. Block 810 may also comprise receiving the transcript, for example from an external source or storage device.

After the first loop, a first audio portion is selected at block 815. In this case, the audio portion is an audio track. This may be represented by an audio file in a file system. The audio file may be extracted from a multimedia file representing combined video and audio content. At block 825, a first language model in the set of language models generated by the first loop is selected. At block 820, the audio track is processed to determine at least a set of confidence values. This processing comprises applying a transcription or speech-to-text operation to the audio track, the operation making use of the currently selected language model. The operation may comprise applying a transcription or speech-to-text engine. For example, a set of confidence values may be associated with a set of words that are detected in the audio track. The set of words, together with timing information, may be used later to perform block 530 of FIG. 5. As shown by block 825, block 820 is repeated for each language model in the set of language models generated by the first loop. As such, a first selected audio track will be processed a number of times; each time a different language model will be used in the transcription or speech-to-text operation. As shown by block 815, a second loop of blocks 820 and 825 is also repeated for each audio track in the present example. Hence, if there are n audio tracks and m transcripts (where typically n equals m) then an output of a third loop of blocks 815, 820 and 825 is (n*m) sets of confidence values.

At block 830, at least one statistical metric is calculated for each set of confidence values. The at least one statistical metric may comprise an average of all confidence values in each set. In certain cases, the set of confidence values may be pre-processed before the statistical metric is calculated, e.g. to remove clearly erroneous classifications. An output of block 830 is thus a set of (n*m) metrics. This output may be represented as an n by m matrix of values. In the present example, the average values are normalized by dividing the values by an average value for all generated confidence values, e.g. all confidence values in the (n*m) sets. The output of block 830 may thus comprise an n by m matrix of confidence value ratios.

At block 840, a language for each audio track is determined based on a set of m confidence value ratios. For example, the maximum value in the set of m confidence value ratios may be determined and this index of this value may indicate the transcript associated with the audio track. If a list of languages is provided and the transcripts are ordered according to this list then the index of the maximum value may be used to extract a language label. Block 840 iterates through each of the n audio tracks to determine a language for each audio track. In certain cases, matrix operations may be applied to determine a language for each audio track. If multiple audio tracks are assigned a common language then a conflict-resolution procedure may be initiated. Further statistical metrics may be calculated for the conflicting sets of confidence values to resolve the conflict. For example, a ratio of the largest and second largest values within each row of m confidence value ratios may be determined; the audio track with the lowest ratio may have its language determination reassigned to the second largest confidence value ratio.

It will be understood that blocks 810, 820, 830 and 840 may be looped in a number of different ways while having the same result. For example, instead of separately looping blocks 810 and 820, these may be looped together. As described above, the method 800 of FIG. 8 and the method of FIG. 5 may be combined. Likewise, the system 700 of FIG. 7 and the systems 400 and 405 of FIGS. 4A and 4C may also be combined. For example, in these cases, once each audio track has been assigned to a particular transcript, a corresponding text equivalent and timing information output by the second component 750 and/or block 820 may be used in the alignment performed by the third component 470 and/or block 530 (i.e. the confidence values discussed in the method 800 of FIG. 8 and/or the system 700 of FIG. 7 may comprise the confidence values 466 as forming one of the components of output 460 in system 400 or system 405). As such, the method 800 of FIG. 8 and/or the system 700 of FIG. 7 may comprise an initial verification operation for an alignment procedure in the case of multiple language tracks.

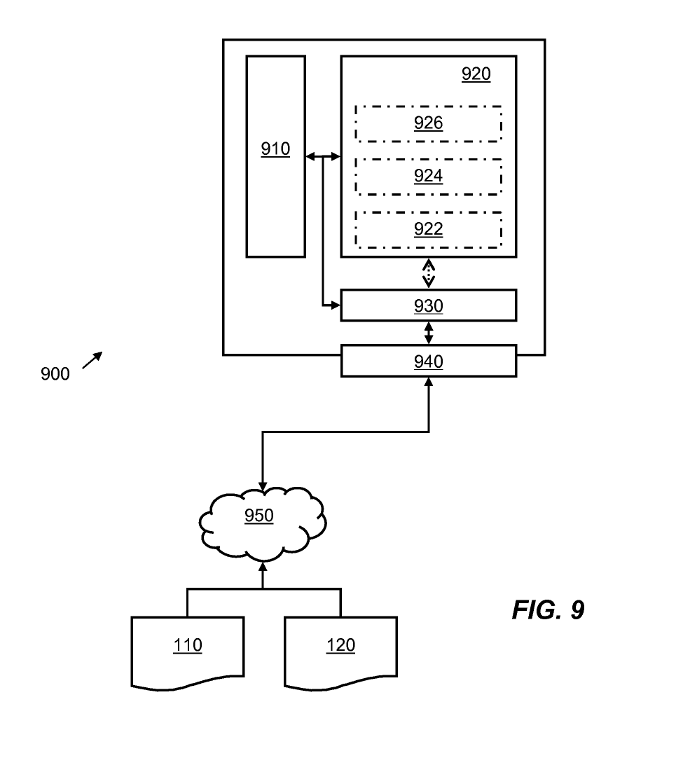

FIG. 9 shows a computing device 900 that may be used to implement certain methods and systems described above. It should be noted that other computing configurations and/or devices may also be used. The computing device 900 comprises at least one or more processors 910 (such as one or more central processing units), working memory 920 (such as at least a portion of random access memory), system bus 930 (such as an input/output interface) and network interface 940. The working memory 920 may be volatile memory, e.g. the contents of the working memory may be lost when a power supply is removed. The one or more processors 910 are communicatively coupled to the working memory 920. In use, the one or more processors 910 are arranged to process computer program code 922-926 stored in working memory 920. The computer program code 922-926 may implement one or more of the system components and/or method steps described herein. The system bus 930 is communicatively coupled to the one or more processors 910. Direct memory access (DMA) may also be used to communicatively couple the system bus 930 to the working memory 920. The system bus 930 may communicatively couple the one or more processors 910 (and/or working memory 920) to one or more peripheral devices, which may include, amongst others: video memory; one or more displays; one or more input peripherals such as mice, keyboards, touch-screens, tablets etc.; one or more non-volatile storage devices, which may be arranged to persistently store computer program code; one or more printers; speakers; microphones; and media drives such as flash, compact or digital versatile disk drives. In use the one or more processors 910 (and/or working memory 920) send and/or receive data using the system bus to said peripheral(s). In FIG. 9, the network interface 940 is also communicatively coupled to the system bus 930 to allow communication over one or more computer networks 950. These networks may be any combination of local and/or wide-area networks, with wired and/or wireless connections. In certain case, audio data 110 and/or text data 120 may be received over the one or more computer networks 950. The capabilities of computing device 900 may also be distributed over a plurality of communicatively coupled systems.

Certain examples described herein present a system to automatically align a transcript with corresponding audio or video content. These examples use speech-to-text capabilities with models trained on audio transcript content to recognise words and phrases present in the content. In certain case, only the content of the audio transcript is used. This ensures a fast and highly accurate speech recognition process. The resulting output can be straightforwardly reconciled with the original transcript in order to add utterance time-markings. The process is robust to inaccurate transcriptions, noise and music in the soundtrack. In addition, an automatic system is described in certain examples to confirm and/or determine the language of each of multiple audio tracks associated with a broadcast video using closed-caption content.

As described in certain examples herein, audio and/or video data for broadcasting may be processed in an improved manner. For example, closed-caption text can be matched against an audio/video track and/or time-positioned with respect to an audio/video track. These techniques may be applied to prepare videos for broadcast, whether that broadcast occurs over the air or other one or more computer networks. Certain described examples offer a highly accurate time alignment procedure as well as providing language detection capabilities to audio content creators and/or broadcasters. Certain described time alignment procedures may be, for example, faster and cheaper than manual alignment, faster and more accurate than an unconstrained speech-to-text operation and are more robust than force-alignment techniques approach. Certain matching techniques provide an ability to confirm that audio data representative of various spoken languages are placed in correct audio tracks.

As described with reference to FIG. 9, at least some aspects of the examples described herein may be implemented using computer processes operating in processing systems or processors. These aspects may also be extended to computer programs, particularly computer programs on or in a carrier, adapted for putting the aspects into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

Similarly, it will be understood that any system referred to herein may in practice be provided by a single chip or integrated circuit or plural chips or integrated circuits, optionally provided as a chipset, an application-specific integrated circuit (ASIC), field-programmable gate array (FPGA), etc. The chip or chips may comprise circuitry (as well as possibly firmware) for embodying at least system components as described above, which are configurable so as to operate in accordance with the described examples. In this regard, the described examples may be implemented at least in part by computer software stored in (non-transitory) memory and executable by the processor, or by hardware, or by a combination of tangibly stored software and hardware (and tangibly stored firmware).

The preceding description has been presented only to illustrate and describe examples of the principles described. For example, the components illustrated in any of the Figures may be implemented as part of a single hardware system, for example using a server architecture, or may form part of a distributed system. In a distributed system one or more components may be locally or remotely located from one or more other components and appropriately communicatively coupled. For example, client-server or peer-to-peer architectures that communicate over local or wide area networks may be used. Certain examples describe alignment of transcripts of media with corresponding audio recordings included with the media. Reference to the term “alignment” may be seen as a form of synchronization and/or resynchronization of transcripts with corresponding audio recordings. Likewise, “alignment” may also be seen as a form of indexing one or more of the transcript and corresponding audio recording, e.g. with respect to time. It is noted that certain examples described above can apply to any type of media which includes audio data including speech and a corresponding transcription of the audio data. In certain examples described herein, the term “transcription” may refer to a conversion of data in an audio domain to data in a visual domain, in particular to the conversion of audio data to data that represents elements of a written language, such as characters, words and/or phrases. In this sense a “transcript” comprises text data that is representative of audible language elements within at least a portion of audio data. A “transcript” may also be considered to be metadata associated with audio data such as an audio recording. Text data such as text data 120 may not be an exact match for spoken elements in an associated audio recording, for example certain words may be omitted or added in the audio recording. Likewise there may be shifts in an audio recording as compared to an original transcript due to editing, insertion of ad breaks, different playback speeds etc.

In general, as described in particular examples herein, an output of a speech recognition process includes a number of lines of text each representing spoken elements in the audio recording and associated with a timecode relative to the audio recording. The term “processing” as used herein may be seen as a form of “parsing”, e.g. sequential processing of data elements. Likewise the term “model” may be seen as synonymous with the term “profile”, e.g. a language profile may comprise a language model. Text data such as 120 that is used as a transcript input may exclude, i.e. not include, timing information. In certain implementations, words in transcript may be block grouped, e.g. by chapter and/or title section of a video recording. As such reference to text data and transcript includes a case where a portion of a larger set of text data is used. Text data such as 120 may originate from manual and/or automated sources, such as human interpreters, original scripts etc. It will be appreciated that a hidden Markov model is one type of dynamic Bayesian network that may be used for speech recognition purposes, according to which a system may be modeled as a Markov process with hidden parameters. Other probability models and networks are possible. Certain speech recognition processes may make use of Viterbi processing.

Any of the data entities described in examples herein may be provided as data files, streams and/or structures. Reference to “receiving” data may comprise accessing said data from an accessible data store or storage device, data stream and/or data structure. Processing described herein may be: performed on and/or offline; performed in parallel and/or series; performed in real-time, near real-time and/or as part of a batch process; and/or may be distributed over a network. Text data may be supplied as a track (e.g. a data track) of media file. It may comprise offline data, e.g. supplied pre-generated rather than transcribed on the fly. It may also, or alternatively, represent automatically generated text. For example, it may represent stored closed-caption text for a live broadcast based on a speech recognition process trained on exact voice of speaker, e.g. a proprietary system belonging to the broadcaster. Any multimedia file described herein, such as an audio track, may have at least one associated start time and stop time that defines a timeline for the multimedia file. This may be used as a reference for the alignment of text data as described herein. The audio data need not be pre-processed to identify and/or extract areas of speech; the described examples may be applied successfully to “noisy” audio recordings comprising, for example, background noise, music, sound effects, stuttered speech, hesitation speech as well as other background speakers. Likewise, received text data need not accurately match the audio data; it may comprise variations and background-related text. The techniques of certain described examples can thus be applied even though the text data is not verbatim, i.e. does not reflect everything that is said. Reference to “words” as described in examples herein may also apply to other language elements such as words or language elements such as phonemes (e.g. “ah”) and/or phrases (e.g. “United States of America”).

It is to be understood that any feature described in relation to any one example may be used alone, or in combination with other features described, and may also be used in combination with one or more features of any other of the examples, or any combination of any other of the examples. Many modifications and variations are possible in light of the above teaching. Moreover, even though the appended claims are provided with single dependencies, multiple dependencies are also possible.

What is claimed is:

1. A method for processing audio data, comprising:
generating a transcript language model based on text data representative of a transcript associated with said audio data;
processing said audio data with a transcription engine to determine at least a set of confidence values for a plurality of language elements in a text output of the transcription engine, the transcription engine using said transcript language model; and
determining whether the text data is associated with said audio data based on said set of confidence values.

2. The method of claim 1, wherein said audio data comprises a plurality of audio tracks for a media item, each audio track having an associated language and the method further comprises:
accessing a plurality of transcripts, each transcript being associated with a particular language;
wherein the step of generating a transcript language model comprises generating a transcript language model for each transcript in the plurality of transcripts;
wherein the step of processing said audio data comprises processing at least one audio track with the transcription engine to determine confidence values associated with use of each transcription language model; and
wherein the step of determining whether the text data is associated with at least a portion of said audio data comprises determining a match between at least one audio track and at least one transcript based on the determined confidence values.

3. The method of claim 1, wherein the step of processing said audio data comprises producing a text output with associated timing information and the method further comprises:
responsive to a determination that the text data is associated with at least a portion of said audio data, reconciling the text output with the text data representative of said transcript so as to append the timing information to the transcript.

4. The method of claim 1, wherein processing said audio data comprises determining a matrix of confidence values.

5. The method of claim 1, wherein the transcript language model is a statistical N-gram model than is configured using said text data representative of said transcript.

6. The method of claim 1, wherein the transcription engine uses an acoustic model representative of phonemic sound patterns in a spoken language.

7. The method of claim 6, wherein the transcription language model embodies statistical data on at least occurrences of words within the spoken language and wherein the transcription engine uses a pronunciation dictionary to words to phonemic sound patterns.

8. The method of claim 1, further comprising, prior to generating a transcript language model:
normalizing the text data representative of said transcript.

9. The method of claim 1, wherein said audio data forms part of a media broadcast and the transcript comprises closed-caption data for said media broadcast.

10. A system processing media data, the media data comprising at least an audio portion, the system comprising:
a first component to instruct configuration of a language model based on text data representative of audible language elements within said audio portion; and
a second component to instruct conversion of the audio portion of the media data to a text equivalent based on said language model, said conversion outputting a set of confidence values for a plurality of language elements in the text equivalent,
wherein the system determines whether the text data is associated with said audio data based on said set of confidence values.

11. The system of claim 10, further comprising:
a third component to compare the text equivalent with the received text data so as to add said timing information to the received text data; and
a fourth component to determine whether the text data is associated with at least a portion of said audio data based on said set of confidence values,
wherein the third component is arranged to perform a comparison responsive to a positive determination from the fourth component.

12. The system of claim 10, comprising:
a speech-to-text engine communicatively coupled to the second component to convert the audio portion of the media data to the text equivalent, the speech-to-text engine making use of the language model and a sound model, the sound model being representative of sound patterns in a spoken language and the language model being representative of word patterns in a written language.

13. The system of claim 10, further comprising:
an interface to receive at least text data associated with the media data, wherein the interface is arranged to convert said received text data to a canonical form.

14. The system of claim 10, wherein:
the media data comprises a plurality of audio portions, each audio portion being associated with a respective language;
the text data comprises a plurality of text portions, each text portion being associated with a respective language;
the first component instructs configuration of a plurality of language models, each language model being based on a respective text portion;
the second component instructs conversion of at least one audio portion of the media data to a plurality of text equivalents, the conversion of a particular audio portion being repeated for each of the plurality of language models; and
the system further comprises:
a fourth component to receive probability variables for language elements within each text equivalent and to determine a language from the set of languages for a particular audio portion based on said probability variables.

15. A non-transitory computer-readable storage medium storing instructions that, when executed by one or more processors, cause the one or more processors to:
generate a transcript language model based on text data representative of a transcript associated with said audio data;
process said audio data with a transcription engine to determine at least a set of confidence values for a plurality of language elements in a text output of the transcription engine, the transcription engine using said transcript language model; and
determine whether the text data is associated with said audio data based on said set of confidence values.
